(19) United States
(12) Patent Application Publication
(10) Pub. No.: US 2003/0161141 A1
(43) Pub. Date: Aug. 28, 2003

(54) Method and apparatus for lighting made from different materials

(76) Inventor: Irwin Kotovsky, Pittsburgh, PA (US)

Correspondence Address: Ansel M. Schwartz, Suite 304, 201 N. Craig Street, Pittsburgh, PA, 15213, US

(21) Appl. No.: 10/084,740

(22) Filed: Feb. 22, 2002

(51) Int. Cl. F21S 8/04; F21V 19/02; F21V 29/00

(52) U.S. Cl. 362/147; 362/373; 362/372; 362/250

(57) ABSTRACT

An apparatus for lighting a room from the room's ceiling. The apparatus includes means for lighting including at least one lamp and one transformer electrically connected to the lamp. The lamp is either a low voltage or a line voltage lamp. The apparatus includes a housing for holding the lamp, the housing having an outer surface made of wood, plastic, glass, marble or synthetic. The apparatus includes means for attaching the housing to the ceiling. A method for forming a lighting apparatus. A method for lighting a room.

### FIELD OF THE INVENTION

The present invention is related to a lighting apparatus having an exterior surface that can be made from a multitude of different materials. More specifically, the present invention is related to a lighting apparatus for low voltage or line voltage lamps that can be made out of or having an exterior surface made out of a multitude of different materials.

### BACKGROUND OF THE INVENTION

Lights have always been a functional necessity in any enclosure from the time they were first available. Besides the light providing a necessary function to allow people to see inside an enclosure, the lights themselves have at times taken on an esthetic or artistic quality to better enhance the environment in which they are placed. The present invention furthers this ascetic or artistic quality by allowing the apparatus for lighting to be able to be of a multitude of different materials depending on the aesthetic environment in which they are found and which the architect or designer wishes to enhance or create.

### SUMMARY OF THE INVENTION

The present invention pertains to an apparatus for lighting a room from the room's ceiling. The apparatus comprises means for lighting including at least one lamp and one transformer electrically connected to the lamp. The lamp is either a low voltage or a line voltage lamp. The apparatus comprises a housing for holding the lamp, the housing having an outer surface made of wood, plastic, glass, marble or synthetic. The apparatus comprises means for attaching the housing to the ceiling.

The present invention pertains to a method for forming a lighting apparatus. The method comprises the steps of placing an outer layer about an interior of a housing. There is the step of introducing a lamp socket connected to a transformer adjacent the housing for either a low voltage or a line voltage lamp.

The present invention pertains to a method for lighting a room. The method comprises the steps of attaching a housing having an interior made of metal and an outer layer made of wood to a ceiling. There is the step of introducing a low voltage or a line voltage lamp into a lamp socket connected to a transformer adjacent the housing.

### BRIEF DESCRIPTION OF THE DRAWINGS

In the accompanying drawings, the preferred embodiment of the invention and preferred methods of practicing the invention are illustrated in which:

FIG. 1 is a schematic representation of an apparatus of the present invention.

FIGS. 2-4 are schematic representations of bottom, side and end views, respectively, of an apparatus whose corners are mitered.

FIGS. 5-7 are schematic representations of bottom, side and end views, respectively, of an apparatus whose corners are butted.

FIGS. 8-10 are schematic representations of an apparatus bottom, side and end views, respectively, whose corners overlap.

FIGS. 11 and 12 are schematic representations of an apparatus perspective view suspended from the ceiling, with a closer view of the lamp, respectively.

### DETAILED DESCRIPTION

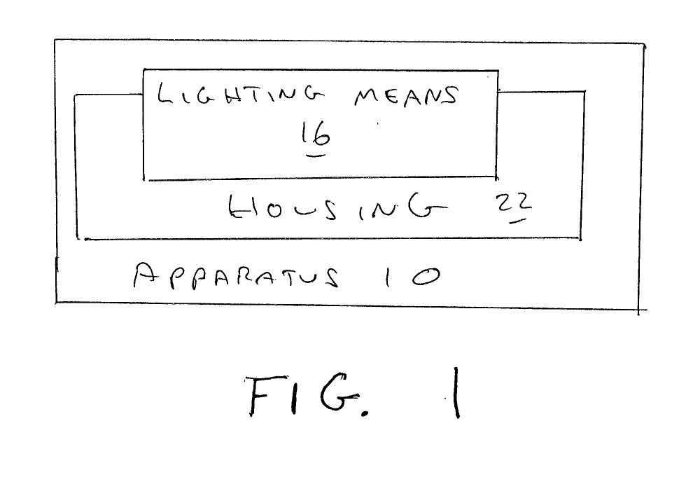

Referring now to the drawings wherein like reference numerals refer to similar or identical parts throughout the several views, and more specifically to FIG. 1 thereof, there is shown an apparatus 10 for lighting a room 12 from the room's 12 ceiling 14. The apparatus 10 comprises means 16 for lighting including at least one lamp 18 and one transformer 20 electrically connected to the lamp 18. The lamp 18 is either a low voltage or a line voltage lamp 18. The apparatus 10 comprises a housing 22 for holding the lamp 18, the housing 22 having an outer surface 24 made of wood, plastic, glass, marble or synthetic. The apparatus 10 can include means for attaching the housing 22 to the ceiling 14.

Preferably, the housing 22 includes an interior 26, and an outer layer 28 positioned about the interior 26, the outer layer 28 having the outer surface 24, the outer layer 28 made of wood, metal, plastic, glass, marble or synthetic. The housing 22 preferably has a rectangular shape. Preferably, the lighting means 16 includes at least a second lamp 18. The lighting means 16 preferably includes a yoke 30 which holds the lamp 18. Preferably, the lighting means 16 includes a gimbal ring 32 assembly having the yoke 30 for holding the lamp 18.

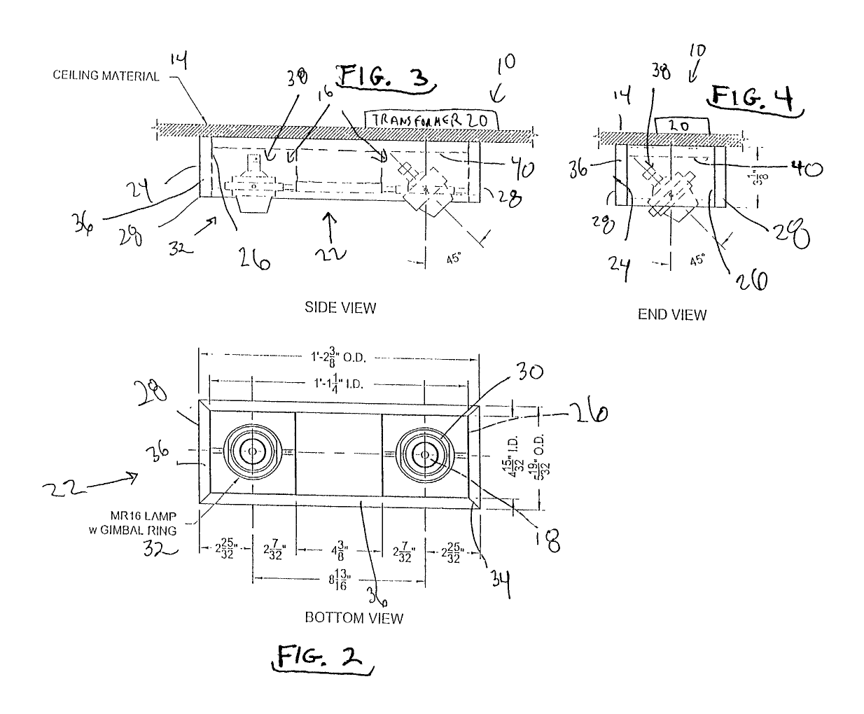

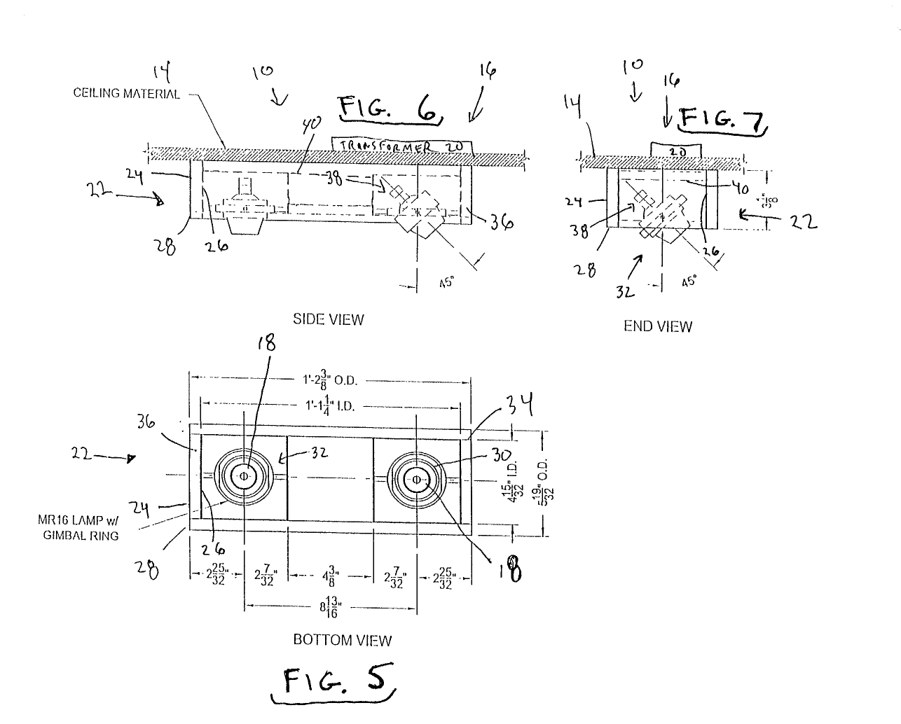

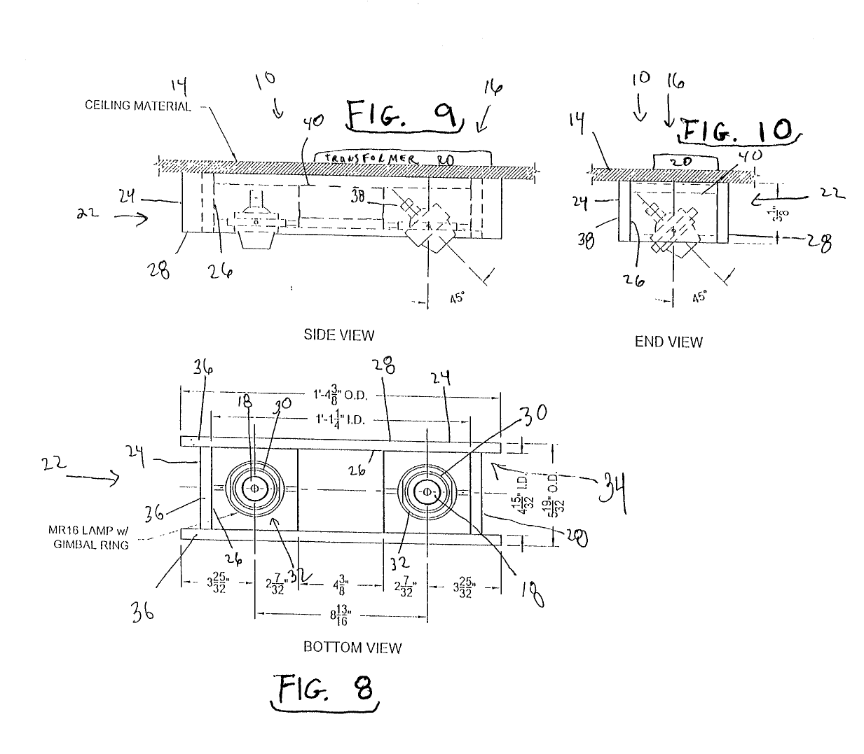

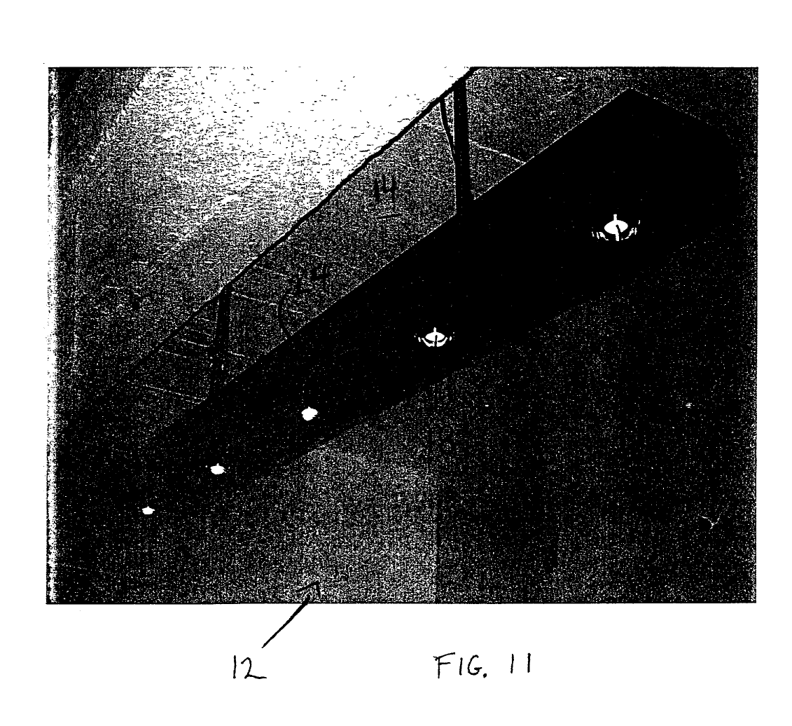

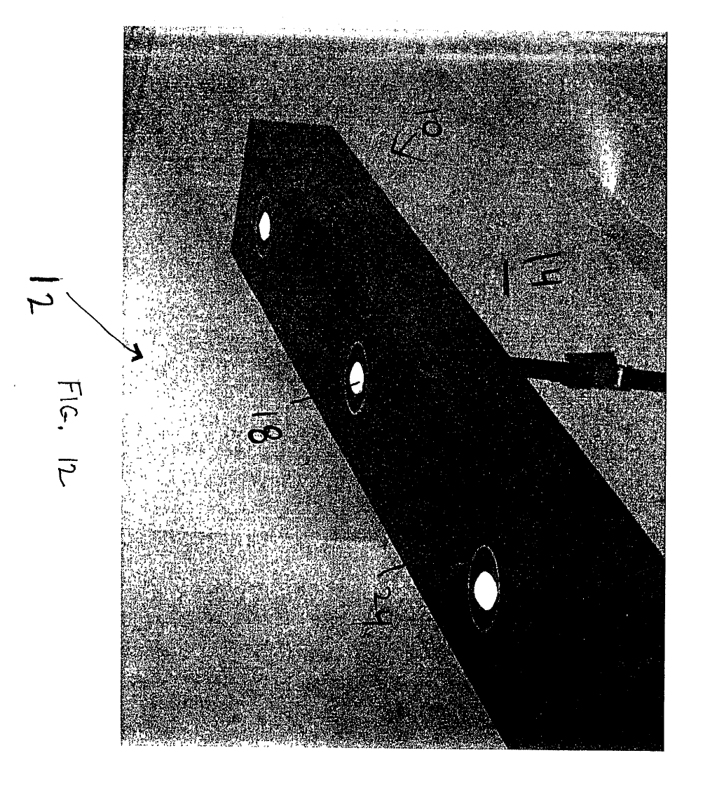

The housing 22 preferably has corners 34 which are mitered, butted, or overlapped, as shown in FIGS. 2-4, 5-7, and 8-10, respectively. Preferably, the outer layer 28 is formed of plates 36. The plates 36 are preferably regressed, flush or protruding with respect to the housing 22 circumference. Preferably, the plates 36 are fixed, interchangeable or removable. The housing 22 is preferably surface mounted, suspended, as shown in FIGS. 11 and 12, semi-recessed, or recessed from the ceiling 14 or wall mounted. The length or long dimension of the housing can be parallel or perpendicular to the wall. Preferably, the lighting means 16 includes a lamp 18 socket 38 for holding the lamp 18, and the housing 22 includes a metal heat plate 40 disposed adjacent the housing 22 top having an opening through which the socket 38 extends. The metal heat plate 40 transmits heat away from the lamp 18 socket 38. The transformer 20 is preferably integral or remote from the housing 22. Preferably, the transformer 20 is attached or detached adjacent the housing 22.

The present invention pertains to a method for forming a lighting apparatus 10. The method comprises the steps of placing an outer layer 28 about an interior 26 of a housing 22. There is the step of introducing a lamp 18 socket 38 connected to a transformer 20 adjacent the housing 22 for either a low voltage or a line voltage lamp 18.

The present invention pertains to a method for lighting a room 12. The method comprises the steps of attaching a housing 22 having an interior 26 made of metal or plastic and an outer layer 28 made of wood to a ceiling 14. There is the step of introducing a low voltage or a line voltage lamp 18 into a lamp 18 socket 38 connected to a transformer 20 adjacent the housing 22.

In the operation of the invention, a lighting apparatus 10, such as that provided by Modular International, Inc. called LINEARS, or found in U.S. Pat. No. 6,234,644, incorporated by reference herein, or essentially any lighting apparatus 10 that has a housing 22 which supports low voltage or line voltage lamps 18 can be the basis for the present invention. The housing 22 for the lamps 18 can be made of entirely, or partially, of wood (solid, laminated, veneered), metal (steel, stainless steel, aluminum), plastics (acrylic, polycarbonate), glass (laminated, tempered, water white), marble (onyx, travertine, stone, ceramic), or synthetic. Alternatively, the housing 22 itself can be of standard metal formation with an outer layer 28 formed of plates 36 made of wood (solid, laminated, veneered), metal (steel, stainless steel, aluminum), plastics (acrylic, polycarbonate), glass (laminated, tempered, water white), marble (onyx, travertine, stone, ceramic), or synthetic. The corner 34 construction of the housing 22 if it is made entirely of a desired material and other than standard metal, or plates 36 are used on a standard metal housing 22, the corner 34 construction can be mitered, butted, or overlapped. The shape of the housing 22 can be round, straight (90 degrees), or angled. The corners 34 themselves can the glued, stapled, pinned or clipped together.

If plates 36 are used, they can be regressed, flush or protruding (extending below the sides) relative to the housing 22. The plates 36 can be fixed to the housing 22 or interchangeable with the housing 22. The plates 36 can be magnetically held, either with magnetic strips adhered to the plates 36, or with magnets strong enough placed inside the housing 22 which also holds the plates 36 to the housing 22 wall. The plates 36 can be screw held, the screws and penetrating through the respective plate and the housing 22 wall. The plates 36 can be Velcro held, with the pins of the Velcro disposed on either the plate or the housing 22 and the loops of the Velcro disposed and in alignment with the pins on the opposing plate or housing 22 side. The plates 36 can be snap or fastener held or held by lift and shift design. The plates 36 can be laser cut, water cut, stamped, forged, bent, machined, molded, die cast or saw cut.

If plates 36 are used, they can be applied only to the surfaces that are exposed for viewing by people in the enclosure in which the lighting apparatus 10 is located. For instance, if the lighting apparatus 10 is recessed, then the plates 36 need only be applied to the bottom surface of the lighting apparatus 10 which is exposed to viewing by people in the enclosure. The mounting of the lighting apparatus 10 can be surface mounted, suspended, semi-recessed, or recessed. In each of these instances, the standard techniques known to one skilled in the art are used to hold the lighting apparatus 10 in position. The length of the lighting apparatus 10, is essentially unconstrained, being able to extend the length of a room 12, if desired.

The lamps 18 and the lighting apparatus 10 can be held by sockets, rings free-floating, yokes, gimbal rings or plug in systems or other commonly used quick disconnect systems in low voltage or line voltage systems. The lamp 18 sockets 38 can be 120 volt candelabra based, intermediate based, medium based, mogel based or bayonet based; or the sockets can be for low voltage lamps, such as MR11, MR16, AR70 or AR111. The lamps 18 can be flush with the bottom, regressed above the bottom, or protruding below the bottom of the housing 22. Transformers 20 and/or gear for the lamps 18 can be integral, remote or contained in attached or detached adjacent housing 22. Linear fluorescent lamps, such as T2 and T5 and BiAx are available, as well as a variety of PL lamps for either clip in or screw in sockets.

A metal plate from which the socket 38 and lamps 18 extend can be used to further facilitate the withdrawal of heat to avoid overheating problems. Additionally, a thermal heat shield is commercially available for MR11, MR16 lamps. It has been found that using the above described materials, in conjunction with the metal plate that is disposed along and the top of the housing 22 and from which the socket 38 and lamps 18 extend, removes enough heat generated by the lamp 18 when it is on to allow proper operation with no greater risk of fire or heat damage than with standard lighting apparatuses of this type serving the same lighting function, and which meets international electrical standards. Any number of lamps 18 can be used, as dictated by the length of the housing 22 and the lighting that is called for from the housing 22.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. An apparatus for lighting a room from the room's ceiling comprising:
means for lighting including at least one lamp and one transformer electrically connected to the lamp, the lamp being either a low voltage or a line voltage lamp; and
a housing for holding the lamp, the housing having an outer surface made of wood, plastic, glass, marble or synthetic.

2. An apparatus as described in claim 1 wherein the housing includes an interior, and an outer layer positioned about the interior, the outer layer having the outer surface, the outer layer made of wood, metal, plastic, glass, marble or synthetic.

3. An apparatus as described in claim 2 wherein the housing has a rectangular shape.

4. An apparatus as described in claim 3 wherein the lighting means includes at least a second lamp.

5. An apparatus as described in claim 4 wherein the lighting means includes a yoke which holds the lamp.

6. An apparatus as described in claim 5 wherein the lighting means includes a gimbal ring assembly having the yoke for holding the lamp.

7. An apparatus as described in claim 6 wherein the housing has corners which are mitered, butted, or overlapped.

8. An apparatus as described in claim 7 wherein the outer layer is formed of plates.

9. An apparatus as described in claim 8 wherein the plates are regressed, flush or protruding with respect to the housing circumference.

10. An apparatus as described in claim 9 wherein the plates are fixed, interchangeable or removable.

11. An apparatus as described in claim 10 wherein the housing is surface mounted, suspended, semi-recessed, or recessed from the ceiling or wall mounted.

12. An apparatus as described in claim 11 wherein the lighting means includes a lamp socket for holding the lamp, and the housing includes a metal heat plate disposed adjacent the housing top having an opening through which the socket extends, the metal heat plate transmitting heat away from the lamp socket.

13. An apparatus as described in claim 12 wherein the transformer is integral or remote from the housing.

14. An apparatus as described in claim 13 wherein the transformer is attached or detached adjacent the housing.

15. A method for forming a lighting apparatus comprising the steps of:
placing an outer layer about an interior of a housing; and
introducing a lamp socket connected to a transformer adjacent the housing for either a low voltage or a line voltage lamp.

16. A method for lighting a room comprising the steps of:
attaching a housing having an interior made of metal or plastic and an outer layer made of wood to a ceiling; and
introducing a low voltage or a line voltage lamp into a lamp socket connected to a transformer adjacent the housing.
